(19) United States
(12) Patent Application Publication
(10) Pub. No.: US 2026/0245288 A1
(43) Pub. Date: Aug. 20, 2026

(54) IMAGE PROCESSING DEVICE AND IMAGE PROCESSING METHOD

(71) Applicant: Sony Interactive Entertainment Inc., Tokyo (JP)

(72) Inventors: Shigeatsu Yoshioka, Tokyo (JP); Yuki Karasawa, Tokyo (JP); Masakazu Suzuoki, Tokyo (JP)

(21) Appl. No.: 19/471,570

(22) PCT Filed: Apr. 7, 2023
(86) PCT No.: PCT/JP2023/014337

§ 371 Date: Oct. 1, 2025

(51) Int. Cl. G06T 15/06; A63F 13/52; G06T 15/20; G06T 19/00

(52) U.S. Cl. CPC G06T 15/06; G06T 15/205; G06T 19/006; A63F 13/52; G06T 2200/24; G06T 2219/024

(57) ABSTRACT

A reference image data acquisition unit 54 of an image processing device 10 acquires data of a reference image representing an overall appearance of a state in which a specific object is excluded from a space to be displayed, from a content server 20. An entire image generation unit 58 refers to the reference image and generates an entire image corresponding to a display viewpoint. A specific object image generation unit 62 generates three-dimensional information regarding the space to be displayed including the specific object, and then generates a specific object image including a visual representation of the specific object as viewed from the display viewpoint. A combining unit 64 combines the entire image with the specific object image and outputs the resultant to a display device 16 through an output unit 66.

### TECHNICAL FIELD

This invention relates to an image processing device and an image processing method for processing and displaying data from a server.

### BACKGROUND ART

Due to enhancement of communication networks and development of image processing technology in recent years, it has become possible to enjoy a variety of electronic content regardless of a viewing environment. For example, in the field of electronic games, a system has become widespread in which a server collects information associated with statuses of individual client terminals, such as the details of user operations and location information, and distributes image data reflecting those pieces of information as needed, thereby enabling a plurality of players to participate in the same game regardless of location.

### SUMMARY

### Technical Problem

In an aspect in which images are distributed from a server regardless of a type of content, with the abundant processing capability of the server, it becomes easy to display high-quality images with minimal influence from processing performance of client terminals. On the other hand, processing of collecting status information from a large number of client terminals and processing of distributing video from the server in response to the status information are always involved, and hence, it is conceivable that a problem arises in responsiveness of display images to status changes in the client terminals.

The present invention has been made in view of such a problem, and it is an object thereof to provide a technology that ensures both image quality and responsiveness in the image processing of electronic content involving distribution from a server.

### Solution to Problem

In order to solve the above-mentioned problem, a certain aspect of the present invention relates to an image processing device. This image processing device includes one or more processors having hardware, in which the one or more processors generate an image of a specific object defined by a predetermined criterion among objects existing in a space to be displayed, acquire basic data of an image representing a state of the space not including the specific object from a server, combine the image of the specific object with an entire image generated on the basis of the basic data, and output data of a display image obtained through the combining.

Another aspect of the present invention relates to an image processing method. This image processing method includes generating an image of a specific object defined by a predetermined criterion among objects existing in a space to be displayed, acquiring basic data of an image representing a state of the space not including the specific object from a server, combining the image of the specific object with an entire image generated on the basis of the basic data, and outputting data of a display image obtained through the combining.

Note that any combination of the above components and conversions of the expressions of the present invention between methods, apparatuses, systems, computer programs, data structures, recording media, and the like are also effective as aspects of the present invention.

### Advantageous Effects of Invention

According to the present invention, it is possible to ensure both image quality and responsiveness in the image processing of electronic content involving distribution from the server.

### BRIEF DESCRIPTION OF DRAWINGS

FIG. 1 is a diagram illustrating a configuration example of an image display system to which the present embodiment can be applied.

FIG. 2 schematically illustrates an example in which a visual representation of a specific object is combined with an entire image to generate a display image according to the present embodiment.

FIG. 3 is a diagram illustrating an internal circuit configuration of an image processing device according to the present embodiment.

FIG. 4 is a diagram illustrating the configurations of functional blocks of the image processing device and a content server according to the present embodiment.

FIG. 5 is a diagram illustrating a processing procedure for generating data of reference images by the content server according to the present embodiment.

FIG. 6 is a diagram illustrating a processing procedure for generating the entire image by the image processing device according to the present embodiment.

FIG. 7 is a diagram illustrating a processing procedure for generating an image of the specific object by the image processing device according to the present embodiment.

FIG. 8 is a diagram illustrating a method of selecting the reference image to be used for the determination of pixel values of an entire image, by an entire image generation unit of the image processing device according to the present embodiment.

FIG. 9 is a diagram illustrating a method of determining the pixel values of the entire image by the entire image generation unit according to the present embodiment.

FIG. 10 is a diagram illustrating processing details in a case where a specific object image generation unit performs ray tracing in S34 of FIG. 7.

### DESCRIPTION OF EMBODIMENT

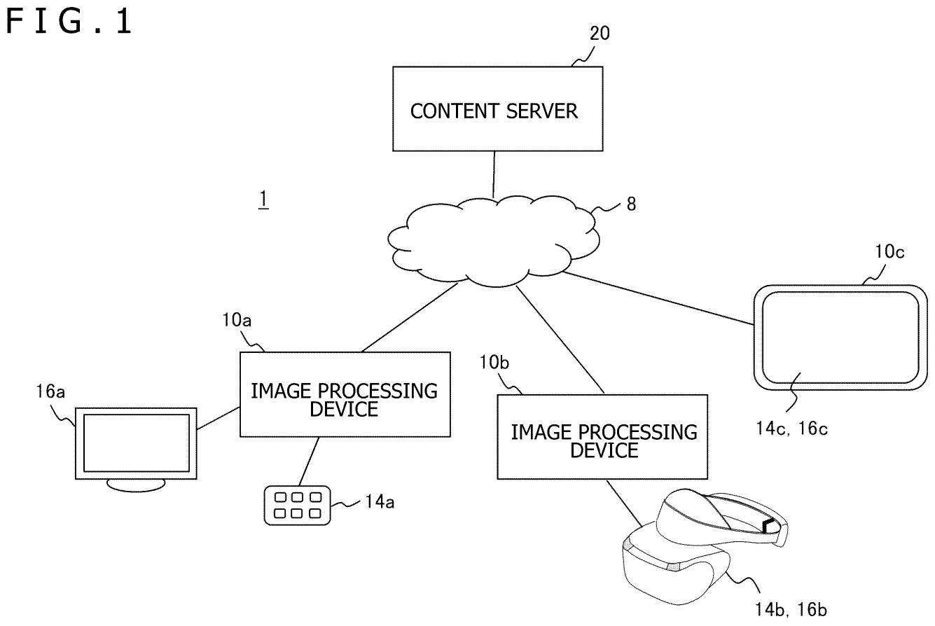

FIG. 1 illustrates a configuration example of an image display system to which the present embodiment can be applied. An image display system 1 includes image processing devices 10a, 10b, and 10c configured to display images in response to user operations and a content server 20 configured to provide image data to be used for display. To the image processing devices 10a, 10b, and 10c, input devices 14a, 14b, and 14c for user operations and display devices 16a, 16b, and 16c configured to display images are connected, respectively. The image processing devices 10a, 10b, and 10c and the content server 20 can establish communication via a network 8 such as a WAN (World Area Network) or a LAN (Local Area Network).

The image processing devices 10a, 10b, and 10c may be connected to the display devices 16a, 16b, and 16c and the input devices 14a, 14b, and 14c by either a wired or wireless connection. Alternatively, two or more of those apparatuses may be integrally formed. For example, in FIG. 1, the image processing device 10b is connected to a head-mounted display, which is the display device 16b. Since the head-mounted display can change the field of view of the display image in response to movements of a user wearing the head-mounted display on the head, the head-mounted display also functions as the input device 14b.

Furthermore, the image processing device 10c is a portable terminal, a tablet terminal, or the like, and is integrally configured with the display device 16c and the input device 14c, which is a touchpad configured to cover a screen of the display device 16c. In this manner, the external shapes and connection forms of the apparatuses illustrated in FIG. 1 are not limited. The number of the image processing devices 10a, 10b, and 10c or the content servers 20 connected to the network 8 is not limited either. Hereinafter, the image processing devices 10a, 10b, and 10c are collectively referred to as an “image processing device 10,” the input devices 14a, 14b, and 14c as an “input device 14,” and the display devices 16a, 16b, and 16c as a “display device 16.”

The input device 14 is a general input device, such as a controller, a keyboard, a mouse, a touchpad, or a joystick, and receives user operations and supplies the user operations to the image processing device 10. The input device 14 may also include various sensors, such as a motion sensor and a camera included in a head-mounted display, a portable terminal, a tablet terminal, or the like, and may supply sensor data from those sensors to the image processing device 10. The display device 16 may be a general display, such as a liquid crystal display, a plasma display, an organic EL (Electro Luminescence) display, a wearable display, or a projector, and displays images output from the image processing device 10.

The content server 20 provides data of content involving image display to the image processing device 10. The type of the content in question is not particularly limited and may be any of electronic games, viewing images, promotional images, web pages, video chat using avatars, and the like. According to the present embodiment, the content server 20 basically generates data of moving images or audio representing the content and immediately transmits the data in question to the image processing device 10, thereby achieving streaming.

In this case, the content server 20 may sequentially acquire information regarding user operations on the input device 14 or sensor data acquired by various sensors, from the image processing device 10, and may have the information or the sensor data reflected in the images or the audio. With this, it becomes possible that a plurality of users participate in the same game or communicate in a virtual world. Here, the content server 20 generates high-quality images by three-dimensional computer graphics (3DCG), for example.

In 3DCG, physical phenomena occurring in a space to be displayed are more accurately represented, thereby making it possible to achieve immersive image expression. As physically based rendering for achieving this, ray tracing has been known. In ray tracing, the propagation of various types of light, such as light from light sources, or diffuse reflection or specular reflection on object surfaces, arriving at a virtual viewpoint is accurately calculated, thereby enabling the more realistic expression of changes in color tone or luminance due to movements of the viewpoint in question or the object to be displayed itself.

With the image display system 1, it becomes possible to generate and display, even if processing performance of the image processing device 10 is low, high-definition images at a high rate through ray tracing by utilizing the abundant processing environment of the content server 20. On the other hand, in an aspect in which the individual statuses of the image processing devices 10 are reflected in the display content, due to processing procedures in which the content server 20 receives information associated with the statuses in question via the network 8, has the information reflected in images or audio, and transmits the information back to the image processing devices 10 via the network 8, non-negligible latency may occur.

However, the problems related to the latency in question vary in importance depending on the details of changes caused in response to user operations or the like. For example, objects that appear or move in response to user operations tend to make latency more perceptible, and particularly in cases such as electronic games, may cause stress to the user. Furthermore, when movements of such objects are to be drawn with high accuracy, the latency tends to further increase. On the other hand, in a case where the colors or materials of objects that remain stationary in the world coordinate system are changed, a certain degree of latency is often hard to perceive or acceptable.

However, the perceptibility and acceptable range of latency naturally vary depending on the details of content, the characteristics and display positions of objects, and the like. Furthermore, in an aspect in which the display field of view is changed in response to user operations or movements of the user, the latency in changing the field of view tends to be perceived, and particularly in the case of a head-mounted display, may become a cause of motion sickness.

Therefore, according to the present embodiment, basically, image changes for which latency is to be minimized are expressed on the image processing device 10 side, and the rest is expressed by the content server 20. Specifically, among objects to be displayed, an object that moves in response to user operations or the like and thus requires minimized latency is selected on the basis of predetermined criteria and directly drawn by the image processing device 10. Hereinafter, the object selected in this way is referred to as a “specific object.” Furthermore, the image processing device 10 acquires basic data of a visual representation representing an entire space to be displayed excluding the specific object, from the content server 20, but performs processing related to changes in the display field of view by itself. Hereinafter, the image without the specific object, in which the field of view is controlled in this way, is referred to as an “entire image.” Then, the image processing device 10 combines the visual representation of the specific object with the entire image to obtain a display image.

The entire image is generated on the basis of high-definition image data generated using the abundant resources of the content server 20. Furthermore, since the visual representation of the specific object is limited to a designated region, high-speed and high-image-quality drawing becomes possible even with the resources of the image processing device 10. Moreover, since the visual representation of the specific object is displayed without involving the content server 20 in the process up to the display, it becomes unnecessary to wait for data transmission. As a result, image expression that ensures both image quality and responsiveness can be achieved.

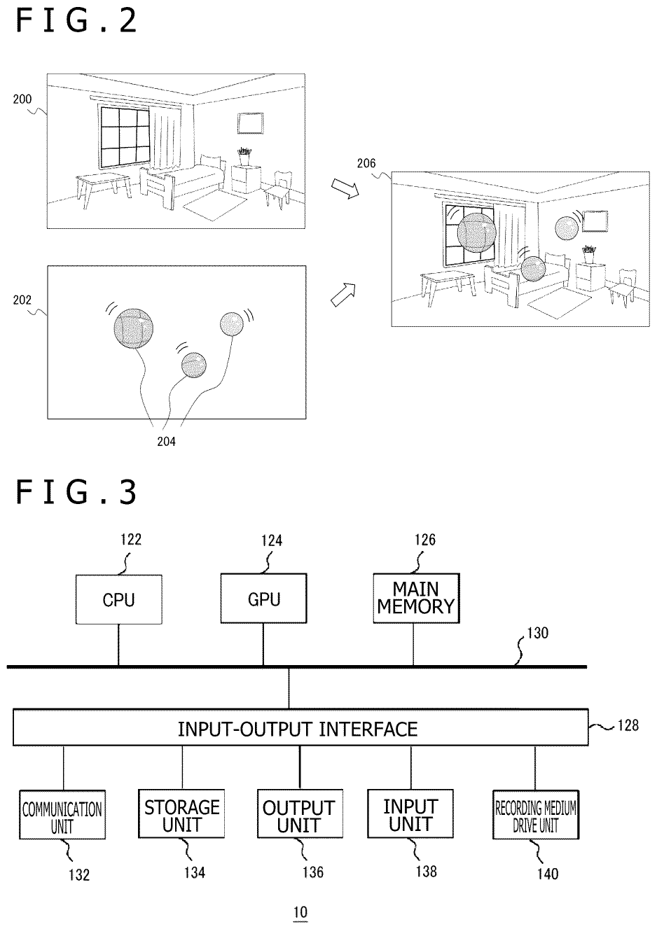

FIG. 2 schematically illustrates an example in which the visual representation of the specific object is combined with the entire image to generate the display image according to the present embodiment. In FIG. 2, an entire image 200 is an image representing the appearance of a state in which the specific object is excluded from an interior space to be displayed, as viewed from a viewpoint for display and a line of sight (hereinafter, sometimes simply referred to as a “display viewpoint”). A specific object image 202 is an image representing, in the same field of view as the entire image 200, the appearance of only three spherical objects 204, which are the specific objects, as viewed from the display viewpoint. The spherical objects 204 are set as the specific objects on the basis of conditions such as being capable of moving by user operations.

The image processing device 10 combines the specific object image 202 with the entire image 200 to generate a display image 206. Note that the display image 206 corresponds to a single frame of a moving image. The entire image 200 and the specific object image 202 are generated using common three-dimensional spatial information. Thus, when interactions occur in the three-dimensional space, such as the spherical objects 204 colliding with and bouncing off objects represented in the entire image 200, on the basis of the spatial information regarding the three-dimensional space, the interactions in question can be reflected in the specific object image 202. In some cases, the interactions may also be represented in the entire image 200.

The image processing device 10 preferably expresses the spherical objects 204 realistically by ray tracing. The spherical objects 204 illustrated in FIG. 2 are assumed to be a highly transparent material such as glass, and are expressed in such a manner that the visual representations of objects behind the spherical objects 204 are transmitted with distortion depending on the refractive index of the spherical objects 204. With ray tracing, not only the transmitted visual representations but also reflections of other objects due to specular reflection, glare due to reflection of light sources, and the like can be represented.

The region that the image processing device 10 directly draws is limited to only the visual representation of the specific object, thereby making it fully possible to adopt ray tracing as the drawing method. However, the drawing method of the specific object by the image processing device 10 is not limited to ray tracing and may be switched to another method, such as rasterization, depending on the processing capabilities of the individual image processing devices 10. Alternatively, the number of specific objects may be adjusted depending on the processing capabilities of the individual image processing devices 10.

The selection of the drawing method and the number of specific objects may be adaptively adjusted on the basis of the area of the visual representation of the specific object. For example, as the area of the visual representation of one of the three spherical objects 204 illustrated in FIG. 2 increases, the drawing method for the other spherical objects may be switched to one with a lower processing load, or the other spherical objects may be excluded from the specific objects. That is, the target to be set as the specific object may be fixed regardless of the scene of the content, or may be changed in the middle of the processing of the content, depending on the situation.

The entire image 200 includes the visual representations of objects excluding the specific object. As a typical example, in a case where a moving object in the three-dimensional space to be displayed is set as the specific object, the visual representations of stationary objects are represented as the entire image 200. However, as described above, in a case where the specific object is changed depending on the processing capability of the image processing device 10 or the like, the objects to be represented in the entire image 200 may also change in various ways. Setting information regarding the specific object is determined by either the image processing device 10 or the content server 20 before the processing of the content starts or during the processing of the content, and is notified to the other to be shared. Alternatively, the specific object may be defined in a program or the like for defining the content.

As described above, the entire image 200 is an image obtained by processing the basic image data, which has been transmitted from the content server 20, by the image processing device 10 so as to correspond to the display viewpoint. To that extent, the type of the basic image data in question is not particularly limited. In the following description, however, it is assumed that data of a plurality of images representing the space to be displayed from a plurality of viewpoints set independently from the display viewpoint is used. For processing of generating the display image using the data in question, for example, the technology disclosed in Japanese Patent Application Laid-Open No. 2018-133063 can be applied. Details are described later.

In any case, the content server 20 preferably generates, by ray tracing, high-definition images realistically representing the space to be displayed excluding the specific object, and transmits the images to the image processing device 10. Hereinafter, the basic images transmitted from the content server 20 are referred to as a “reference image,” and the viewpoints set at the time of generating the basic images are referred to as a “reference viewpoint.”

In the space to be displayed, if the plurality of reference viewpoints are set dispersedly in a movable range assumed for the display viewpoint, and the reference images are prepared for each reference viewpoint, the entire image 200 corresponding to the display viewpoint can be represented with high accuracy and high speed by utilizing the colors of the objects as viewed from a viewpoint near the display viewpoint. With this, the image processing device 10 can express not only changes in the specific object but also changes in the field of view with minimal latency.

FIG. 3 illustrates an internal circuit configuration of the image processing device 10. The image processing device 10 includes a CPU (Central Processing Unit) 122, a GPU (Graphics Processing Unit) 124, and a main memory 126. These respective units are connected to each other via a bus 130. An input-output interface 128 is further connected to the bus 130. The input-output interface 128 is connected to a communication unit 132 including a peripheral device interface such as a USB (Universal Serial Bus) or a wired or wireless a LAN network interface, a storage unit 134 such as a hard disk drive or a nonvolatile memory, an output unit 136 configured to output data to the display device 16, an input unit 138 configured to receive data from the input device 14, and a recording medium drive unit 140 configured to drive removable recording media such as magnetic disks, optical discs, or semiconductor memories.

The CPU 122 controls the entirety of the image processing device 10 by executing an operating system stored in the storage unit 134. The CPU 122 also executes various programs that have been read out from a removable recording medium and loaded into the main memory 126 or downloaded via the communication unit 132. The GPU 124 has the function of a geometry engine and the function of a rendering processor. The GPU 124 performs drawing processing in accordance with drawing commands from the CPU 122 and stores the display image in a frame buffer, which is not illustrated. Then, the display image stored in the frame buffer is converted into a video signal and output to the output unit 136. The main memory 126 is configured by a RAM (Random Access Memory) and stores programs and data necessary for processing. The content server 20 may also have a similar internal circuit configuration.

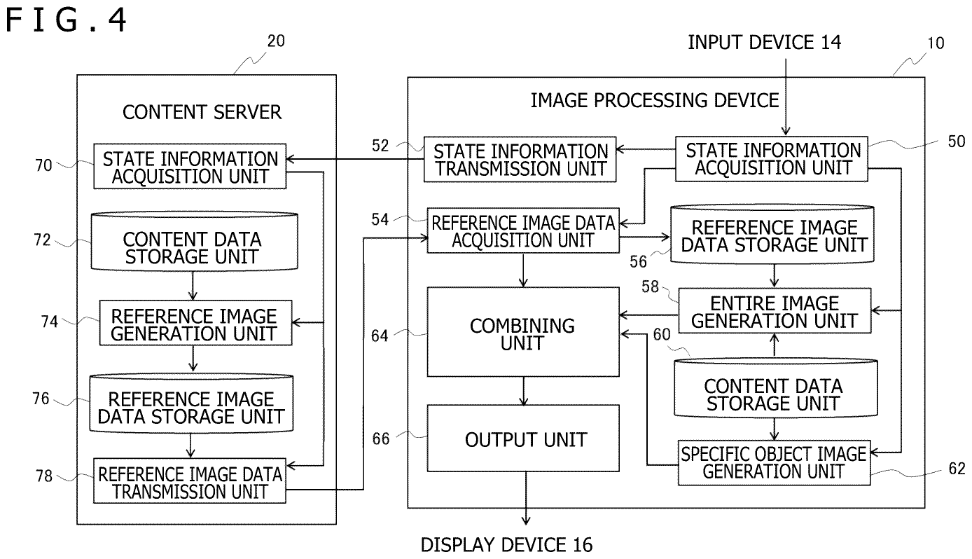

FIG. 4 illustrates the configurations of functional blocks of the image processing device 10 and the content server 20 according to the present embodiment. Note that the image processing device 10 and the content server 20 may perform various types of processing necessary for carrying out the content, such as the information processing or audio processing of electronic games. However, FIG. 4 mainly illustrates functional blocks related to image processing.

The functional blocks illustrated in FIG. 4 can be achieved in hardware by the configurations, such as the CPU, the GPU, and various memories, illustrated in FIG. 3, and in software by programs loaded into the memory from a recording medium or the like to exhibit various functions such as a data input function, a data holding function, an image processing function, and a communication function. Thus, it is understood by those skilled in the art that these functional blocks can be achieved in various forms by hardware alone, software alone, or a combination thereof and are not limited to any of them.

The image processing device 10 includes a state information acquisition unit 50 configured to acquire state information regarding the image processing device 10 itself or the display device 16, a state information transmission unit 52 configured to transmit the state information in question to the content server 20, a reference image data acquisition unit 54 configured to acquire data regarding the reference images from the content server 20, and a reference image data storage unit 56 configured to store the data of the reference images. The image processing device 10 further includes an entire image generation unit 58 configured to generate the entire image, a specific object image generation unit 62 configured to generate the image of the specific object, a content data storage unit 60 configured to store data to be used for the generation of various images, a combining unit 64 configured to combine the entire image with the image of the specific object, and an output unit 66 configured to output data of the combined image to the display device 16.

The state information acquisition unit 50 acquires, as the state information regarding the image processing device 10, the details of user operations, such as content selection, application activation and deactivation, and various operations on the content, from the input device 14. Here, the various operations on the content may include not only operations on the objects to be displayed but also operations on the display viewpoint.

When the display device 16 is achieved by a movable body such as a head-mounted display, a portable terminal, or a tablet terminal, and the display viewpoint is linked with movements of those apparatuses, the state information acquisition unit 50 acquires sensor data by motion sensors or cameras built into those apparatuses, as the state information regarding the display device 16, at a predetermined rate. In this case, the state information acquisition unit 50 further derives the position and posture of the display device 16 at a predetermined rate by using a known method, on the basis of the acquired sensor data. The state information transmission unit 52 transmits the state information acquired by the state information acquisition unit 50 to the content server 20 as needed.

The reference image data acquisition unit 54 acquires the data of the reference images transmitted from the content server 20. As described above, the data of the reference images is data that associates the reference images representing the objects other than the specific object with the reference viewpoints set at the time of generating each reference image. The data of the reference images further includes depth images corresponding to each reference image. The depth images are data representing, for each pixel, a distance (depth value) from the view screen to the object represented in the reference image. The depth images are utilized for the selection of the reference image to be referred to in determining pixel values of the entire image.

The reference image data storage unit 56 stores the data of the reference images acquired by the reference image data acquisition unit 54. The more the display viewpoint deviates from the reference viewpoint, the less likely the reference image corresponding to the reference viewpoint in question is used for the generation of the entire image. Therefore, the reference image data storage unit 56 may selectively store the data of the reference images corresponding to the reference viewpoints within a predetermined range from the display viewpoint, thereby saving necessary storage capacity. In this case, the reference image data acquisition unit 54 specifies the display viewpoint at a predetermined rate on the basis of the state information acquired by the state information acquisition unit 50 or information defined in advance in the content, and optimizes the reference images to be stored in the reference image data storage unit 56 accordingly.

The entire image generation unit 58 generates the entire image not including the visual representation of the specific object at a predetermined rate using the data of the reference images. Specifically, the entire image generation unit 58 sequentially determines the display viewpoint on the basis of the state information acquired by the state information acquisition unit 50 or the information defined in advance in the content, and sets the view screen corresponding thereto. Then, the objects other than the specific object, which are arranged in the three-dimensional space, are projected onto the view screen in question, thereby associating the pixels on the view screen with the points on the object surfaces.

Moreover, the entire image generation unit 58 specifies pixels representing the corresponding points on the reference image and samples color information regarding the pixels to determine the pixel values of the entire image. However, as described above, the method of generating the entire image by the entire image generation unit 58 is not limited to this. For example, the entire image generated by the content server 20 may be appropriately subjected to viewpoint conversion to obtain a final entire image.

The specific object image generation unit 62 generates the image of the specific object at a predetermined rate. The specific object image generation unit 62 also sequentially determines the display viewpoint on the basis of the state information acquired by the state information acquisition unit 50 or the information defined in advance in the content, and sets the view screen corresponding thereto. Next, the specific object image generation unit 62 projects the specific object onto the view screen in question to specify the region of the visual representation of the specific object, and determines pixel values for the pixels within the region by ray tracing, for example.

Note that the specific object image generation unit 62 may specify, among the visual representations represented in the entire image, regions in which the specific object is reflected, regions in which the visual representation of the specific object is transmitted, the region of the shadow of the specific object, or the like in the process of ray tracing, and may include the regions in question in the drawing target, as the visual representation of the specific object. With this, the visual representations of those regions can be changed in synchronization with movements of the specific object.

The content data storage unit 60 stores data necessary for the generation of the display image, such as three-dimensional models of the objects existing in the space to be displayed, and programs for defining arrangements and movements. The specific object image generation unit 62 generates the image of the specific object on the basis of the data stored in the content data storage unit 60 and the details of user operations acquired by the state information acquisition unit 50. The data stored in the content data storage unit 60 is also used by the entire image generation unit 58 in processing of projecting the objects other than the specific object onto the view screen.

The combining unit 64 combines the entire image generated by the entire image generation unit 58 with the image of the specific object generated by the specific object image generation unit 62, thereby completing a frame representing the display image. The output unit 66 sequentially outputs data of the frame obtained through combining by the combining unit 64 to the display device 16.

The content server 20 includes a state information acquisition unit 70 configured to acquire the state information from the image processing device 10, a content data storage unit 72 configured to store data to be used for the generation of the reference images, a reference image generation unit 74 configured to generate the reference images, a reference image data storage unit 76 configured to store the data of the reference images, and a reference image data transmission unit 78 configured to transmit the data of the reference images to the image processing device 10.

The state information acquisition unit 70 acquires, as needed, the state information regarding the image processing device 10 or the display device 16 described above. In a case where a plurality of users are participating in a single piece of content being carried out, the state information acquisition unit 70 acquires the state information from each of the image processing devices 10. Note that, in a case where the specific objects operated by the users of the respective image processing devices 10 are also displayed on the display devices 16 of other users, the state information acquisition unit 70 also acquires, as the state information, information associated with user operations on the individual specific objects or information associated with the states of the specific objects in question themselves, from each of the image processing devices 10. The content data storage unit 72 stores data necessary for the generation of the reference images, such as the program of the content or the three-dimensional models of the objects.

The reference image generation unit 74 generates the reference images on the basis of various types of data stored in the content data storage unit 72. As described above, the reference images are images representing the state in which the specific object is excluded from the space to be displayed, from the plurality of reference viewpoints. A memory inside the reference image generation unit 74 stores in advance setting information associated with the position coordinates of the reference viewpoints distributed so as to cover the movable range of the display viewpoint. With this, the reference image generation unit 74 generates the reference images corresponding to each reference viewpoint.

In a case where there is no movement or change in the objects to be represented in the entire image, the reference image generation unit 74 only needs to generate a set of reference images once. Alternatively, the reference image generation unit 74 may change or move the objects to be displayed, in response to user operations in the image processing device 10 or definitions in the content, and may update the reference images accordingly. In a case where a plurality of users are participating in a single piece of content being carried out, the reference image generation unit 74 may generate the reference images reflecting operations by all the users.

In any case, the reference image generation unit 74 preferably draws high-quality reference images using a physically based rendering method such as ray tracing. Furthermore, the reference image generation unit 74 preferably generates the reference images with an angle of view wider than the angle of view of the display image for each reference viewpoint. For example, the reference image generation unit 74 generates full-dome images centered on each reference viewpoint. With this, the wide-range display image can be generated with a small number of reference images. The reference image generation unit 74 also generates the depth images corresponding to the reference images. In a case where the reference images are full-dome images, since the view screen is a spherical surface, the depth value is the distance to the object in a normal direction of the spherical surface in question.

The reference image data storage unit 76 stores pairs of the reference images and the depth images generated by the reference image generation unit 74, in association with information regarding the position coordinates of the reference viewpoints set at the time of generating those images. The reference image data transmission unit 78 appropriately compresses and encodes, among the data of the reference images stored in the reference image data storage unit 76, data that is likely to be used for the generation of the entire image in the image processing device 10, and transmits the resultant to the image processing device 10.

For example, the reference image data transmission unit 78 extracts the data of the reference images corresponding to the reference viewpoints within the predetermined range from the display viewpoint in the three-dimensional space to be displayed, and transmits the data to the image processing device 10. In this case, the reference image data transmission unit 78 acquires the display viewpoint in each of the image processing devices 10 at a predetermined rate on the basis of the state information acquired by the state information acquisition unit 70 or the information defined in advance in the content, and determines the data of the reference images to be transmitted.

Note that, as described above, in a case where the specific objects operated by the users of the respective image processing devices 10 are also displayed on the display devices 16 of other users, the reference image data transmission unit 78 also transmits, to the image processing devices 10 of all the users, the state information representing the details of the operations in question or the states of the specific objects. In this case, it is desirable to utilize a protocol that achieves high-speed communication, such as UDP (User Datagram Protocol), separately from communication of other data, for the transmission and reception of the information associated with the specific objects between the image processing device 10 and the server 20. At this time, the specific object image generation unit 62 of the image processing device 10 generates an image as described above using the information transmitted at high speed from the server 20 and includes the image in the display image, thereby making it possible to also display the specific objects of other users with low latency.

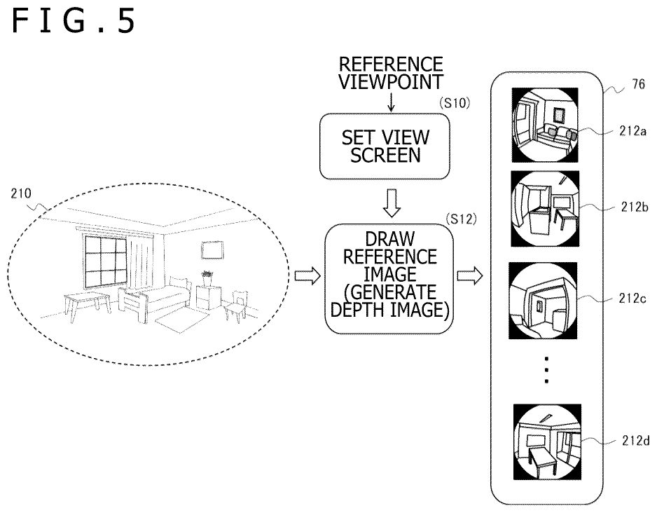

FIG. 5 illustrates a processing procedure for generating the data of the reference images by the content server 20. The reference image generation unit 74 of the content server 20 first generates three-dimensional spatial information 210 representing the space to be displayed in the world coordinate system. The three-dimensional spatial information 210 includes data to be used in general 3DCG, such as three-dimensional meshes representing the positions and postures of, among the objects forming the space to be displayed, the objects excluding the specific object, as well as the shapes of each object, the materials of the surfaces, and the positions of the light sources. These pieces of information may be those defined in the content program or the like stored in the content data storage unit 72, or may be those selected in response to user operations on the image processing device 10 side, which have been acquired by the state information acquisition unit 70.

On the other hand, the reference image generation unit 74 sets the view screen so as to correspond to the reference viewpoint set in advance (S10). Then, the reference image generation unit 74 generates the reference image by drawing the appearance of the objects existing in the space in question on the view screen using the three-dimensional spatial information 210 (S12). For example, in the case of performing ray tracing, the reference image generation unit 74 generates light rays that pass through each pixel on the view screen from the reference viewpoint and samples the colors on the objects that are the arrival destinations of the rays in question, thereby determining pixel values. With ray tracing, since pixel values can be determined for each pixel through independent calculations, the parallelization of processing is easy.

Note that, in S12, the reference image generation unit 74 also generates the depth image corresponding to the generated reference image. In a case where the reference image is drawn by ray tracing, the distance to the object surface can easily be acquired in the process of calculating the paths of the rays from each pixel. By carrying out the processing in S10 and S12 for all the reference viewpoints set in advance, reference images 212a, 212b, 212c, 212d, and the like for the respective reference viewpoints are generated and stored in the reference image data storage unit 76.

In the example illustrated in FIG. 5, the reference images 212a, 212b, 212c, 212d, and the like are generated as full-dome images. Furthermore, as described above, each of the reference images 212a, 212b, 212c, 212d, and the like is associated with the depth images and the information regarding the reference viewpoints. Since the set of the reference images 212a, 212b, 212c, 212d, and the like can be used in all the image processing devices 10 in common, the processing load related to drawing is approximately constant regardless of the number of the image processing devices 10. Furthermore, the visual representation of the specific object is not included in the reference images, and restrictions related to responsiveness are thus loosened, so that, even in a case where slight changes are expressed, high-resolution images can be represented over a relatively long time.

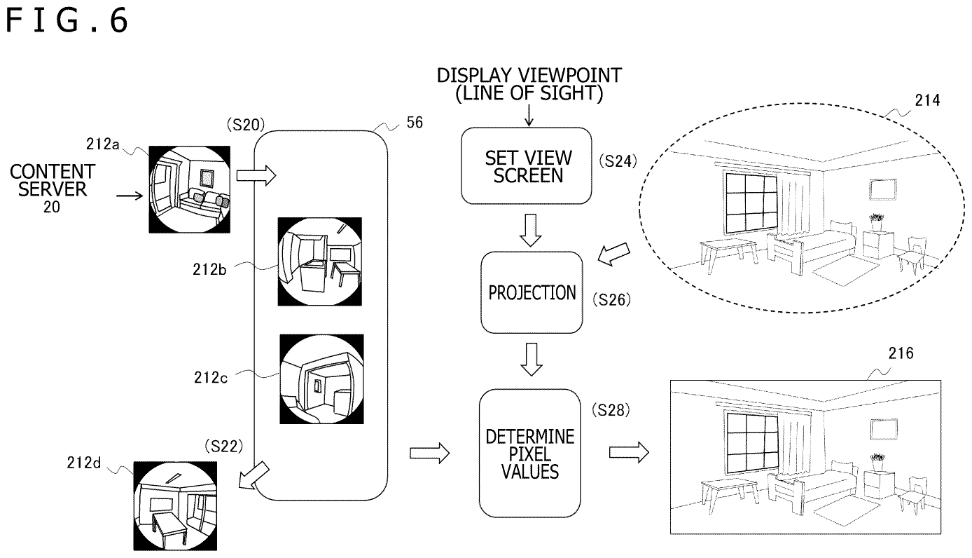

FIG. 6 illustrates a processing procedure for generating the entire image by the image processing device 10. First, the reference image data storage unit 56 of the image processing device 10 stores data of the reference images 212a, 212b, 212c, 212d, and the like transmitted from the content server 20 (S20). Here, as described above, the content server 20 may acquire, as needed, the individual display viewpoints of the image processing devices 10, extract the reference image data corresponding to the reference viewpoints within the predetermined range from the display viewpoints in question, and then transmit the reference image data. With this, the data of the reference images stored in the reference image data storage unit 56 is limited, so that the storage capacity necessary for storage can be saved.

When the display viewpoint moves, the content server 20 additionally transmits, to the image processing device 10, the data of the reference images newly required depending on the movement destination or the movement route. On the other hand, the reference image data acquisition unit 54 of the image processing device 10 deletes, from the reference image data storage unit 56, the data of the reference images corresponding to the reference viewpoints that have deviated from the predetermined range due to the movement of the display viewpoint (S22). The example illustrated in FIG. 6 illustrates how the data of the reference image 212a, which has been newly transmitted from the content server 20, is stored in the reference image data acquisition unit 54, while the data of the reference image 212d, which has been stored originally, is deleted.

The data of the reference images is updated depending on movements of the display viewpoint in this manner, thereby enabling the reference image data storage area in the reference image data storage unit 56 to be approximately constant. Furthermore, in a case where the details of the reference images themselves are not updated, the data of the wide-range reference images in a range that can be accepted by the storage capacity of the reference image data storage unit 56 is transmitted first, thereby suppressing the transmission frequency of the data of the reference images during operation to enable a reduction in bandwidth necessary for communication to be achieved. In a case where the details of the reference images themselves are updated, the content server 20 transmits the data of the reference images to the image processing device 10 each time updating is performed. With this, the latest reference images are stored in the reference image data storage unit 56.

On the other hand, the entire image generation unit 58 of the image processing device 10 generates three-dimensional spatial information 214 representing the space to be displayed in the world coordinate system. The three-dimensional spatial information 214 includes data of three-dimensional meshes representing the positions, postures, and shapes of, among the objects forming the space to be displayed, the objects excluding the specific object. That is, the three-dimensional spatial information 214 is common information to the three-dimensional spatial information 210 generated by the content server 20. However, for the generation of the entire image, only three-dimensional information regarding the positions, postures, and shapes of the objects is satisfactory, so that the association of other data, such as material, can be omitted.

Furthermore, the entire image generation unit 58 sequentially determines the display viewpoint or the line of sight on the basis of, for example, the state information regarding the image processing device 10 or the display device 16, and sets the view screen so as to correspond thereto (S24). Then, the entire image generation unit 58 projects the shapes of the objects other than the specific object onto the view screen by a general method of performing perspective transformation of a three-dimensional mesh using the three-dimensional spatial information 214 (S26). With this, the positions on the view screen plane are associated with the points on the object surfaces in the three-dimensional space.

Then, the entire image generation unit 58 determines the values of pixels forming the visual representations of the objects projected onto the view screen (S28). At this time, as described above, the entire image generation unit 58 reads out the data of the reference image from the reference image data storage unit 56, and extracts and utilizes the pixel on the reference image that represents the same point on the object as the target pixel. Therefore, the entire image generation unit 58 selects, among the reference images corresponding to the reference viewpoints that are close to the display viewpoint, the reference image in which the same point as the target pixel is represented as a visual representation.

Then, the entire image generation unit 58 reads out a pixel value representing the point in question from the selected reference image, and determines a pixel value through averaging with a weight based on the distance and the angle between the display viewpoint and the reference viewpoint. Pixel values are similarly determined for all the pixels on the view screen to complete an entire image 216. With such a pixel value determination method, through the light load calculation including reading out corresponding pixel values from the reference image and weighted averaging, the high-definition entire image 216 that is close to an image in a case where ray tracing is performed can be generated. The entire image generation unit 58 repeats the processing procedure illustrated in FIG. 6 at a predetermined rate. With this, the field of view of the entire image 216 can be changed with low latency against movements of the display viewpoint and changes in the line of sight.

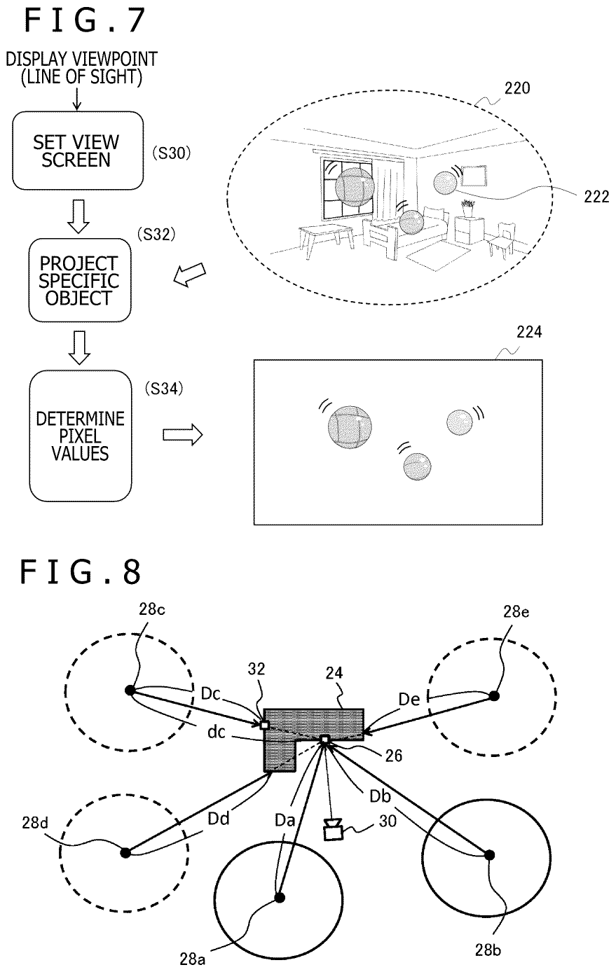

FIG. 7 illustrates a processing procedure for generating the image of the specific object by the image processing device 10. The specific object image generation unit 62 of the image processing device 10 generates three-dimensional spatial information 220 representing the space to be displayed in the world coordinate system. The three-dimensional spatial information 220 is basically common to the three-dimensional spatial information 210 generated by the content server 20, but differs in including the specific object (for example, spherical object 222) within the space. Movements of the specific object are determined on the basis of the state information acquired by the state information acquisition unit 50 or the information defined in advance in the content. As described above, in the three-dimensional spatial information 220, interactions between the specific object and other objects may occur.

Furthermore, the specific object image generation unit 62 sequentially determines the display viewpoint or the line of sight on the basis of, for example, the state information regarding the image processing device 10 or the display device 16, and sets the view screen so as to correspond thereto (S30). Then, the specific object image generation unit 62 projects the specific object onto the view screen by a general method of performing perspective transformation of a three-dimensional mesh using the three-dimensional spatial information 220 (S32). With this, the specific object image generation unit 62 determines the region of the visual representation of the specific object to be drawn by itself from the three-dimensional model.

Then, the specific object image generation unit 62 determines the values of the pixels forming the visual representation of the specific object (S34). For example, the specific object image generation unit 62 performs ray tracing only for the region of the visual representation of the specific object. In the case of the image processing device 10 with low processing capability, the specific object image generation unit 62 may draw the visual representation of the specific object through rasterization. In this case, the processing processes in S32 and S34 are simultaneously executed. In any case, the specific object image generation unit 62 can generate a specific object image 224 in which only the visual representation of the specific object is represented on the view screen. The specific object image generation unit 62 repeats the processing procedure illustrated in FIG. 7 at a predetermined rate. With this, in addition to movements of the display viewpoint and changes in the line of sight, movements of the specific object itself can be reflected in the specific object image 224 with low latency.

The combining unit 64 of the image processing device 10 combines the entire image 216 illustrated in FIG. 6 with the specific object image 224 illustrated in FIG. 7 to generate a single frame. For example, the combining unit 64 overwrites the region of pixels, for which pixel values are given in the specific object image 224, of the entire image 216, with the pixel values in question. Alternatively, the entire image generation unit 58 may generate the entire image excluding the region of the visual representation of the specific object, and the combining unit 64 may fit the visual representation of the specific object into a region having no pixel value in the entire image 216. In this case, the entire image generation unit 58 can determine a region to be excluded from the target to be drawn as the entire image, by including the information regarding the specific object in the three-dimensional spatial information 214 illustrated in FIG. 6.

In the generation of the specific object image 224, the three-dimensional spatial information 220 common to the three-dimensional spatial information 210 or 214 to be used for the generation of the reference images or the entire image illustrated in FIG. 5 or FIG. 6 is used. With this, changes due to interactions with the surrounding objects can be reflected in the visual representation of the specific object. The specific object image 224, which has such changes, is combined with the entire image 216, thereby enabling interactions between the objects represented in the two to be expressed similarly to general images without combining.

Next, the method of selecting the reference image and determining the pixel values of the entire image by the entire image generation unit 58 of the image processing device 10 in S28 of FIG. 6 is described in more detail. FIG. 8 is a diagram illustrating the method of selecting the reference image to be used for the determination of the pixel values of the entire image, by the entire image generation unit 58 of the image processing device 10. FIG. 8 illustrates a state in which a space to be displayed including an object 24 is viewed from above. It is assumed that, in this space, five reference viewpoints 28a to 28e are set and data of reference images are generated for the respective reference viewpoints. In FIG. 8, the circles centered at the reference viewpoints 28a to 28e schematically indicate the screen surfaces of the reference images prepared as full-dome images.

When the display viewpoint is assumed to be at the position of a virtual camera 30, the entire image generation unit 58 determines the view screen so as to correspond to the virtual camera 30 in question and projects a model shape of the object 24. As a result, the correspondence relation between the pixels on the view screen and the positions on the surface of the object 24 is found out. Then, for example, in the case of determining the value of a pixel representing a visual representation of a point 26 on the surface of the object 24, the entire image generation unit 58 first specifies which reference image represents the point 26 in question as a visual representation.

Since the position coordinates of each of the reference viewpoints 28a to 28e and the point 26 in the world coordinate system are known, the distances between those points are easily obtained. In FIG. 8, those distances are indicated by lengths of line segments connecting each of the reference viewpoints 28a to 28e to the point 26. Furthermore, if the point 26 is inversely projected onto the view screens for each reference viewpoint, the positions of the pixels at which the visual representation of the point 26 is to appear in each reference image can also be specified. On the other hand, depending on the position of the reference viewpoint, the point 26 may be on a back side of the object or may be hidden by another object in front, and the visual representation of the point 26 does not appear at the position in question in the reference image.

Therefore, the entire image generation unit 58 checks the depth images corresponding to each reference image. The pixel value of the depth image represents the distance from the screen surface to the object that appears as a visual representation in the corresponding reference image. Thus, the distance from the reference viewpoint to the point 26 is compared with the depth value of the pixel at which the visual representation of the point 26 is to appear in the depth image, thereby determining whether or not the visual representation in question is the visual representation of the point 26.

For example, there is a point 32 on the back side of the object 24 on the line of sight from the reference viewpoint 28c to the point 26, and hence, the pixel at which the visual representation of the point 26 is to appear in the corresponding reference image actually represents a visual representation of the point 32. Thus, a value indicated by the pixel in the corresponding depth image is the distance to the point 32, and a distance Dc obtained through a conversion into a value starting from the reference viewpoint 28c is obviously smaller than a distance dc to the point 26, which is calculated from the coordinate values. Therefore, the entire image generation unit 58 excludes, when the difference between the distance Dc obtained from the depth image and the distance dc to the point 26, which is obtained from the coordinate values, is equal to or greater than a threshold value, the reference image in question from the calculation of the pixel value representing the point 26.

Similarly, distances Dd and De obtained from the depth images for the reference viewpoints 28d and 28e, which are the distances to the object at the corresponding pixels, are excluded from the calculation as the differences from the distances from the respective reference viewpoints 28d and 28e to the point 26 are equal to or greater than the threshold value. On the other hand, distances Da and Db obtained from the depth images for the reference viewpoints 28a and 28b, which are the distances to the object at the corresponding pixels, can be specified as being substantially the same as the distances from the respective reference viewpoints 28a and 28b to the point 26, through a threshold value determination. The entire image generation unit 58 selects, for each pixel on the view screen, the reference image to be used for the calculation of the pixel value, by performing screening using the depth value in this manner.

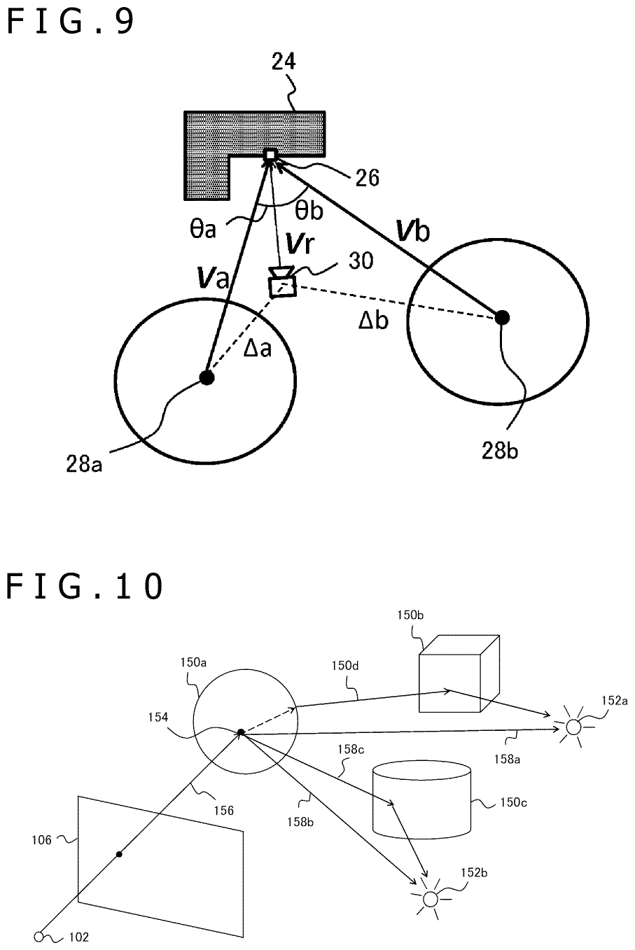

FIG. 9 is a diagram illustrating a method of determining the pixel values of the entire image by the entire image generation unit 58. As illustrated in FIG. 8, it is assumed that it has been found out that the visual representation of the point 26 of the object 24 is represented in the reference images for the reference viewpoints 28a and 28b. The entire image generation unit 58 basically determines the pixel value of the visual representation of the point 26 in the entire image by blending the pixel values of the visual representation of the point 26 in those reference images.

Here, the entire image generation unit 58 calculates a pixel value C in the entire image as follows, where c₁ and c₂ are the pixel values (color values) of the visual representation of the point 26 in the reference images corresponding to the reference viewpoints 28a and 28b, respectively.

$$C = {w}_{1} \cdot {c}_{1} + {w}_{2} \cdot {c}_{2}$$

Here, coefficients w₁ and w₂ are weights having a relation of w₁+w₂=1. That is, the coefficients w₁ and w₂ represent the contribution rates of the reference images and are determined on the basis of the positional relations between the reference viewpoints 28a and 28b and the virtual camera 30 representing the display viewpoint. For example, a larger coefficient is set as the distance from the virtual camera 30 to the reference viewpoint is shorter, thereby increasing the contribution rate.

In this case, when the distances from the virtual camera 30 to the reference viewpoints 28a and 28b are denoted by Δa and Δb and sum=1/Δa²+1/Δb² holds, the weight coefficients are considered to be set to the following functions.

$${w}_{1} = ( 1 / Δ {a}^{2} ) / sum$$

$${w}_{2} = ( 1 / Δ {b}^{2} ) / sum$$

The above equations are generalized as follows, where N is the number of reference images used, i (1≤i≤N) is the identification number of the reference viewpoint, Δi is the distance from the virtual camera 30 to the i-th reference viewpoint, cᵢ is the corresponding pixel value in each reference image, and wᵢ is the weight coefficient. However, these equations are not intended to limit the calculation formula.

$$C = {\sum }_{i = 1}^{N} {w}_{i} \cdot {c}_{i} {w}_{i} = \frac{1}{Δ {i}^{2}} \cdot \frac{1}{sum} , sum = {\sum }_{i = 1}^{N} \frac{1}{Δ {i}^{2}} \qquad [ Math . 1 ]$$

Note that, in the above equations, in a case where Δi is 0, that is, in a case where the virtual camera 30 matches any of the reference viewpoints, the weight coefficient for the pixel value of the corresponding reference image is set to 1, and the weight coefficients for the pixel values of other reference images are set to 0. With this, the reference image created with high accuracy for the viewpoint in question can be reflected in the entire image as it is.

Furthermore, the parameters to be used for the calculation of the weight coefficients are not limited to the distances from the virtual camera to the reference viewpoints. For example, the weight coefficients may be based on angles θa and θb (0≤θa and θb≤90°) formed by line of sight vectors Va and Vb from each reference viewpoint to the point 26 with respect to a line of sight vector Vr from the virtual camera 30 to the point 26. For example, using inner products (Va·Vr) and (Vb·Vr) between the vectors Va and Vb and the vector Vr, the weight coefficients are calculated as follows.

$${w}_{1} = ( Va / Vr ) / ( ( Va \cdot Vr ) + ( Vb \cdot Vr ) )$$

$${w}_{2} = ( Vb / Vr ) / ( ( Va \cdot Vr ) + ( Vb \cdot Vr ) )$$

Similarly to the above, these equations are generalized as follows, where N is the number of reference images used, Vᵢ is the line of sight vector from a reference viewpoint i to the point 26, and wᵢ is the weight coefficient.

$${w}_{i} = \frac{( {V}_{i} \cdot Vr )}{{\sum }_{i = 1}^{N} ( {V}_{i} \cdot Vr )} \qquad [ Math . 2 ]$$

In any case, as long as a calculation rule is introduced such that the reference viewpoint that is closer to the virtual camera 30 in terms of the state with respect to the point 26 has a larger weight coefficient, the specific calculation formula is not particularly limited. The “closeness of state” may be evaluated multifacetedly from both distance and angle to determine the weight coefficients.

FIG. 10 is a diagram illustrating processing details in a case where the specific object image generation unit 62 performs ray tracing in S34 of FIG. 7. In ray tracing, rays that pass through each pixel on a view screen 106 from a viewpoint 102 are generated, and the color at the arrival point of the ray is sampled to determine the pixel value. With this, not only the color of the object itself due to diffuse reflection but also shadows, reflections due to specular reflection, visual representations transmitted through translucent objects, and the like can be accurately expressed. In the example of FIG. 10, a ray 156 that has arrived at a point 154 on the surface of an object 150a probabilistically arrives at light sources 152a and 152b (rays 158a and 158b), or arrives at another object 150c due to specular reflection (ray 158c).

In a case where the object 150a is translucent, a ray 150d that has passed through inside the object from the point 154 to be refracted arrives at another object 150b. The rays that have arrived at the other objects 150b and 150c eventually arrive at the light sources 152a and 152b. The color of the point 154 is represented through the superposition of the colors of those rays. That is, the color of the point 154 reflects not only the color of the object 150a itself but also the colors of the other objects 150b and 150c and the influence of the light sources 152a and 152b. For example, when the object 150a is the specific object, the specific object image generation unit 62 can represent, on the surface of the object 150a, the reflected visual representation of the other object 150c, the transmitted visual representation of the object 150b, and the like by tracing the rays as illustrated in FIG. 10.

On the other hand, in a case where the object 150a moves or deforms, in the real world, the changes also occur in the visual representation of the object 150a reflected on other objects (for example, object 150c). Furthermore, the shadow of the object 150a appearing on surrounding surfaces, such as floors and walls, which are not illustrated, the visual representation of the object 150a transmitted through other objects, and the like also change. If the objects other than the object 150a are represented in the entire image and the visual representations of the surfaces of the objects are not updated, an unnatural situation occurs where, even though the object 150a itself is moving, the shadow, the reflected visual representation, and the transmitted visual representation do not move. Furthermore, it is conceivable that, even if the content server 20 updates those visual representations, the changes lag behind the object 150a on the display, resulting in an unnatural appearance.

Therefore, the specific object image generation unit 62 also includes the regions affected by movements and deformations of the specific object in the entire image in the drawing target, as the visual representation of the specific object. The regions affected by movements and deformations of the specific object are, as described above, the regions in which the specific object is reflected, the regions in which the visual representation of the specific object is transmitted, the region of the shadow of the specific object, and the like. Those regions can be specified in the ray tracing process in drawing the specific object itself through ray tracing as illustrated in FIG. 10. In addition to the specific object itself, the regions affected by the specific object are drawn in the image processing device 10, thereby enabling the generation of natural display images without discrepancy between the two.

According to the embodiment described above, in the image processing of electronic content involving distribution from the server, the visual representations of some objects selected in accordance with predetermined criteria are directly drawn by the client-side image processing device. With this, regarding the specific object for which the latency until display is desired to be minimized, such as an object that moves in response to user operations, the drawing can be completed without the server, thereby enabling high responsiveness to be achieved. Furthermore, since the regions to be drawn are limited, it becomes easy to generate high-quality visual representations even with the processing capability of the image processing device.

The entire image representing the objects other than the specific object is generated by the image processing device using the basic images transmitted from the server. With this, while the images generated using the abundant resources of the server are used as a base, the display field of view is changed with low latency with respect to user operations and the state of the display device. Furthermore, since the data of the basic images in question can be shared among the image processing devices, regardless of the number of image processing devices, the processing load on the server side can be suppressed at a certain level. With this, the basic images, and by extension, the entire image, can be generated with high quality. The basic images are prepared with a wide angle of view, such as full-dome images. This enables a reduction in the frequency of data transmission from the server to the image processing device, thereby making it less likely for display latency due to communication congestion to occur.

Moreover, the image processing device also includes secondary visual representations such as the shadow, reflected visual representation, and transmitted visual representation of the specific object in the target that the image processing device directly draws. With this, natural image expression in which those visual representations are linked with movements of the specific object can be achieved. From the above, a display form that ensures both quality and responsiveness by efficiently utilizing the processing capabilities of both the image processing device and the server can be achieved.

The present invention has been described above on the basis of the embodiment. The embodiment is an example, and it is understood by those skilled in the art that various modifications of combinations of each component and each processing process of the embodiment are possible, and that such modifications are also within the scope of the present invention.

### INDUSTRIAL APPLICABILITY

As described above, the present invention can be utilized for various information processing apparatuses such as game consoles, head-mounted displays, display devices, portable terminals, and personal computers, image display systems including any of them, and the like.

### REFERENCE SIGNS LIST

1: Image display system
10: Image processing device
14: Input device
16: Display device
20: Content server
50: State information acquisition unit
52: State information transmission unit
54: Reference image data acquisition unit
56: Reference image data storage unit
58: Entire image generation unit
60: Content data storage unit
62: Specific object image generation unit
64: Combining unit
66: Output unit
70: State information acquisition unit
72: Content data storage unit
74: Reference image generation unit
76: Reference image data storage unit
78: Reference image data transmission unit
122: CPU
124: GPU
126: Main memory

1. An image processing device comprising:
one or more processors configured to perform operations comprising:
generating an image of a specific object defined by a predetermined criterion among objects existing in a space to be displayed,
acquiring basic data of an image representing a state of the space not including the specific object from a server,
combining the image of the specific object with an entire image generated on a basis of the basic data, and
outputting data of a display image obtained through the combining.

2. The image processing device according to claim 1, wherein the one or more processors are configured to generate the image of the specific object corresponding to a viewpoint for display, on a basis of three-dimensional information regarding the space including the specific object.

3. The image processing device according to claim 1, wherein the one or more processors are configured to set an object having movement in the space as the specific object.

4. The image processing device according to claim 2, wherein the one or more processors are configured to represent a movement due to an interaction with an object other than the specific object in the three-dimensional information, in the image of the specific object.

5. The image processing device according to claim 2, wherein the one or more processors are configured to specify a region on a surface of an object other than the specific object that changes due to a movement of the specific object, on the basis of the three-dimensional information, and include a visual representation of the region in the image of the specific object.

6. The image processing device according to claim 2, wherein the one or more processors are configured to represent, by ray tracing, a reflected visual representation and a transmitted visual representation of an object other than the specific object, which appear on a surface of the specific object, in the image of the specific object.

7. The image processing device according to claim 1, wherein the one or more processors are configured to acquire, as the basic data, data of a reference image corresponding to a reference viewpoint set independently of a viewpoint for display, the data being generated on a basis of three-dimensional information regarding the space not including the specific object, and generate the entire image corresponding to the viewpoint for display with use of the reference image.

8. The image processing device according to claim 7, wherein the one or more processors are configured to project a shape of the space not including the specific object onto a view screen corresponding to the viewpoint for display on the basis of the three-dimensional information regarding the space, and then determine a pixel value by sampling the reference image, thereby generating the entire image.

9. The image processing device according to claim 8, wherein the one or more processors are configured to set the reference image corresponding to a corresponding reference viewpoint of a plurality of reference viewpoints of the reference viewpoint set as a sampling target, and perform weighting based on a positional relation between the viewpoint for display and the reference viewpoint, thereby determining a pixel value of the entire image.

10. The image processing device according to claim 7, wherein the one or more processors are configured to acquire, from the server, the data of the reference image corresponding to the reference viewpoint within a predetermined range from the viewpoint for display and store the data in a storage unit, and delete, from the storage unit, the data of the reference image corresponding to the reference viewpoint that has deviated from the predetermined range due to a movement of the viewpoint for display.

11. The image processing device according to claim 7, wherein the one or more processors are configured to acquire, from the server, data of a full-dome image from the reference viewpoint as the basic data.

12. The image processing device according to claim 1, wherein the one or more processors are configured to acquire information associated with the specific object operated by a user of another image processing device, from the server, and further combine the image of the specific object generated on a basis of the information acquired.

13. An image processing method comprising:
generating an image of a specific object defined by a predetermined criterion among objects existing in a space to be displayed;
acquiring basic data of an image representing a state of the space not including the specific object from a server;
combining the image of the specific object with an entire image generated on a basis of the basic data; and
outputting data of a display image obtained through the combining.

14. One or more non-transitory computer-readable media that store instructions, which, when executed by one or more computer processors, cause the one or more computer processors to perform operations comprising:
generating an image of a specific object defined by a predetermined criterion among objects existing in a space to be displayed;
acquiring basic data of an image representing a state of the space not including the specific object from a server;
combining the image of the specific object with an entire image generated on a basis of the basic data; and
outputting data of a display image obtained through the combining.

15. The image processing method according to claim 13, comprising acquiring, as the basic data, data of a reference image corresponding to a reference viewpoint set independently of a viewpoint for display, the data being generated on a basis of three-dimensional information regarding the space not including the specific object, and generating the entire image corresponding to the viewpoint for display with use of the reference image.

16. The image processing method according to claim 15, comprising projecting a shape of the space not including the specific object onto a view screen corresponding to the viewpoint for display on the basis of the three-dimensional information regarding the space, and then determining a pixel value by sampling the reference image, thereby generating the entire image.

17. The image processing method according to claim 16, comprising setting the reference image corresponding to a corresponding reference viewpoint of a plurality of reference viewpoints of the reference viewpoint set as a sampling target, and performing weighting based on a positional relation between the viewpoint for display and the reference viewpoint, thereby determining a pixel value of the entire image.

18. The image processing method according to claim 15, comprising acquiring, from the server, the data of the reference image corresponding to the reference viewpoint within a predetermined range from the viewpoint for display and storing the data in a storage unit, and deleting, from the storage unit, the data of the reference image corresponding to the reference viewpoint that has deviated from the predetermined range due to a movement of the viewpoint for display.

19. The image processing method according to claim 15, comprising acquiring, from the server, data of a full-dome image from the reference viewpoint as the basic data.

20. The image processing method according to claim 13, comprising acquiring information associated with the specific object operated by a user of another image processing device, from the server, and further combining the image of the specific object generated on a basis of the information acquired.
